(19) United States
(12) Patent Application Publication
(10) Pub. No.: US 2025/0079850 A1
(43) Pub. Date: Mar. 6, 2025

(54) Dispatching Method and Device for Integrated Energy System

(71) Applicant: Hitachi, Ltd., Tokyo (JP)

(72) Inventors: Wei WEI, Beijing (CN); Lian Zhu SHAN, Beijing (CN); Song Jie FENG, Beijing (CN); Dai ZHANG, Beijing (CN); Yu IKEMOTO, Beijing (CN)

(21) Appl. No.: 18/817,990

(22) Filed: Aug. 28, 2024

(30) Foreign Application Priority Data
Sep. 6, 2023 (CN) 202311149583.X

(51) Int. Cl. H02J 3/46; H02J 3/00; H02J 3/38

(52) U.S. Cl. CPC H02J 3/46; H02J 3/004; H02J 3/381; H02J 2203/10; H02J 2203/20; H02J 2300/20

(57) ABSTRACT

A dispatching method and device for an integrated energy system is provided according to the present disclosure. The method includes: constructing an integrated energy system model and simplified component models, performing a rough optimization of a system flexibility with predicted data from renewable energy nodes; determining feasibility constraints according to flexibility optimization results; finally considering operation costs on power and heat generating sides, and implementing a real-time dispatching with real-time data from the renewable energy nodes. The method effectively combines day-ahead scheduling and real-time dispatching by fully utilizing the system flexibility to reduce impacts of prediction errors and achieves strong optimality.

### CROSS-REFERENCE TO RELATED APPLICATION

The application claims a priority to Chinese Patent Application No. 202311149583.X filed on Sep. 6, 2023, the disclosure of which is incorporated in its entirety by reference herein.

### FIELD

The present disclosure relates to the field of power scheduling technologies, in particular to a dispatching method and device for an integrated energy system. (Chinese Patent CN104616208B)

### BACKGROUND

The excessive use of fossil fuels has caused climate change and serious environmental problems. In order to reduce carbon emissions, renewable energy has been largely used in new power systems in recent years. Among them, an integrated energy system mainly based on renewable energy is considered to be a very promising development framework due to its multi-energy integrated coupling characteristics and efficient energy utilization, which can be widely used in industrial parks or urban systems. In the integrated energy system, electricity and heat are two major energy carriers on the demand side. On the one hand, renewable energy sources and auxiliary co-generation units on the power and heat generation sides can generate clean electricity and heat with high efficiency. On the other hand, battery energy storage and heat storage devices can provide additional flexibility for systems to deal with uncertainties in renewable energy generation, ensuring a real-time power balance for both electricity and heat.

An online dispatching for an integrated energy system has become a key research topic. Existing researches can be broadly divided into three categories depending on modeling methods of uncertainties.

The first category of research, focus on the perspective of day-ahead scheduling, which mainly adopts two-stage optimization approaches, such as stochastic optimization, robust optimization and distributed robust optimization. Stochastic optimization involves modeling uncertainties through sampled scenarios and minimizing expected costs. Robust optimization involves optimizing the cost of the worst case within a predetermined uncertainty set. Distributionally robust optimization assumes that the probability distribution of uncertainties is imprecise, focusing on optimizing the cost under the most unfavorable probability distribution, which merges the advantages of the stochastic optimization and the robust optimization. However, the two-stage optimization model assumes that real-time scheduling is conducted after all uncertainty parameters have been observed, whereas in reality, the uncertainty is observed sequentially and chronologically, often referred to as “non-anticipativity”.

The second category of research adopts dynamic programming framework to solve the problem with non-anticipativity. Using the dynamic programming, real-time decisions can be made according to the observed uncertainties and the Bellman optimality principle. Reinforcement learning is a typical representative of dynamic programming. However, intensive data is required to train the real-time cost function of dynamic programming, and the convergence guarantee and interpretability of the algorithm are also problems to be studied.

The last category of research involves implementing online dispatching through explicit or implicit policies. Explicit policy refers to enforcing an affine relationship between a real-time dispatching value and an uncertainty parameter, but the optimality will be adversely affected. On the other hand, implicit policy offers upper and lower bounds for real-time dispatch variables in the form of constraints. Compared with the explicit policy, although the optimality is improved, there is no mature technical framework at present.

Moreover, none of the above three categories of research have realized a combination of day-ahead scheduling and real-time dispatching, nor have they considered prediction errors in day-ahead predictions, leading to great difficulties in the practical application of integrated energy systems.

Model predictive control (MPC) is a widely applied approach in the online dispatching of integrated energy systems. This approach adopts a framework of rolling optimization, where at each moment, it solves a deterministic optimization problem for the current and short-term future time horizons based on short-term predictions of potential uncertainties, and obtains a current pre-optimal decision. In a real-time operation, adjustment to operating states of various components will be made according to actual renewable energy generation.

The MPC approach for solving a rolling optimization problem facilitates the consideration of the synergistic relationship among numerous components, providing notable advantages within the real-time dispatching of integrated energy systems that have multiple energy sources coupled. In addition, owing to the predictions and the real-time adjustment, it demonstrates both enhanced economic efficiency and optimality in operating. However, this approach necessitates high precision in predictions; in systems with a substantial proportion of renewable energy sources, prediction inaccuracies are often significant, significantly affecting the calculation results of MPC. In addition, the predictions for renewable energy tend to be short-term, leading to the short-sightedness of rolling optimization that results in inadequate scheduling of energy storage and make it difficult to handle with deferrable loads in the systems.

To address these problems, it is necessary to propose a dispatching method for an integrated energy system, which effectively combines day-ahead scheduling and real-time dispatching by fully utilizing system flexibility to reduce impacts of prediction errors, and achieves strong optimality.

### SUMMARY

According to at least one of embodiments of the present disclosure, a dispatching method and device for an integrated energy system is provided, which effectively combines day-ahead scheduling and real-time dispatching by fully utilizing system flexibility to reduce impacts of prediction errors, and achieves strong optimality.

In one aspect, a dispatching method for an integrated energy system is provided according to at least one of embodiments of the present disclosure. The method includes:
constructing a component power model for each component of the integrated energy system, and constructing a system model of the integrated energy system according to the component power models and power(s) at renewable energy nodes, wherein the component comprises one or more of the following: a heat generating component, a power generating component, a combined heat and power generating component, a power storage component, a heat storage component and a load, and the load includes at least one of a fixed thermal load, a fixed electrical load or a deferrable electrical load;
optimizing a flexibility of the integrated energy system to obtain flexibility optimization results, by utilizing the system model and predicted data from the renewable energy nodes;
determining feasibility constraints of the integrated energy system according to the flexibility optimization results; and
using the feasibility constraints and an operation cost of the integrated energy system as constraints and an optimization target respectively, and implementing a real-time dispatching of the integrated energy system with real-time data from the renewable energy nodes.

Optionally, the constructing the component power model for each component of the integrated energy system comprises one or more of the following:
constructing a heat generation model based on a thermal power output for the heat generating component;
constructing a power generation model based on an electric power output for the power generating component;
constructing a power generation model based on an electric power output and a heat generation model based on a thermal power output for the combined heat and power generating component;
constructing an electric energy model based on charging and discharging powers for the power storage component;
constructing a thermal energy model based on heat storage charging and discharging powers for the heat storage component;
constructing an electrical load model based on a fixed electric power for the fixed electrical load;
constructing a total power relaxation model based on a deferrable electric power for the deferrable electrical load; or
constructing a heat load model based on a fixed heat power for the fixed heat load.

Optionally, the constructing the system model of the integrated energy system according to the component power models and the power(s) at the renewable energy nodes comprises:
constructing a real-time power balance model of electric energy of the integrated energy system according to the power(s) of the renewable energy nodes and electric powers of the components existing in the integrated energy system, wherein the electric powers include: an electric power output of the power generating components, an electric power output of the combined heat and power generating components, charging and discharging powers of the power storage components, a fixed electric power of the fixed electrical loads, or a deferrable electric power of the deferrable electrical loads; and,
constructing a real-time power balance model of thermal energy of the integrated energy system according to thermal powers of the components existing in the integrated energy system, wherein the thermal powers include: a thermal power of the heat generating components, a thermal power of the combined heat and power generating components, thermal storage charging and discharging powers of the thermal storage components, or a fixed thermal power of the fixed thermal loads.

Optionally, the optimizing the flexibility of the integrated energy system to obtain the flexibility optimization results, by utilizing the system model and the predicted data from the renewable energy nodes comprises:
representing the power of the renewable energy nodes as a function of the electric powers of the components of the integrated energy system, according to the real-time power balance model of the electric energy of the integrated energy system;
quantitatively characterizing the flexibility of the integrated energy system in each time period as a difference between upper and lower limits of the power of the renewable energy nodes in the time period;
constructing a first objective function of the flexibilities of the integrated energy system in multiple time periods, according to the upper and lower limits of the flexibility of the integrated energy system in each time period, wherein the first objective function aims to maximize the flexibility and evenly distribute it in the multiple time periods; and performing an optimization calculation to obtain the system flexibility optimization results, based on the first objective function; wherein constraints of the first objective function include:
upper and lower limits of a power output of each component of the integrated energy system in each time period satisfying the component power model corresponding to the component;
the upper and lower limits of the flexibility of the integrated energy system in each time period corresponding to the upper and lower limits of the power output of the component of the integrated energy system in the time period, respectively;
relative constraints of renewable energy; or
relative conditions of feasibility.

Optionally, the relative constraints of renewable energy comprise:
the upper limit of the flexibility of the integrated energy system in each time period being greater than or equal to a product of a first coefficient and the power of a renewable energy node in the time period, and less than or equal to the power of a second renewable energy node in the time period;
the lower limit of the flexibility of the integrated energy system in each time period being greater than or equal to 0, and less than or equal to a product of a second coefficient and the power of the renewable energy node in the time period; or
the first coefficient and the second coefficient are both preset positive numbers greater than 0 and less than 1.

Optionally, the relative conditions of the feasibility comprise:
the upper limit of the flexibility of the integrated energy system in each time period is greater than or equal to the lower limit of the flexibility of the integrated energy system in the time period; or
the upper limit of the power output of each component of the integrated energy system in each time period is greater than or equal to the lower limit of the power output of the component in the time period.

Optionally, the determining the feasibility constraints of the integrated energy system according to the flexibility optimization results comprises:
obtaining upper and lower limits of outputs of the components of the integrated energy system in each time period, according to the flexibility optimization results;
determining upper and lower limits of a power of electric power supply and upper and lower limits of a power of thermal power supply of the integrated energy system, according to the upper and lower limits of the outputs of the components of the integrated energy system in each time period;
setting feasibility constraints of electric power supply, according to the upper and lower limits of the power of electric power supply of the integrated energy system, wherein the electric power supply of the integrated energy system includes: actual utilization power of renewable energy nodes running in real time in the current period, power purchased from a power grid in the current period, or electrical power output of each component running in real time in the current period; and
setting feasibility constraints of thermal power supply, according to the upper and lower limits of the power of thermal power supply of the integrated energy system, wherein the thermal power supply of the integrated energy system includes: thermal power output of each component running in real time in the current period.

Optionally, the using the feasibility constraints and the operation cost of the integrated energy system as the constraints and the optimization target respectively, and implementing the real-time dispatching of the integrated energy system with the real-time data from the renewable energy nodes comprises:
constructing a second objective function of operation costs of power and heat generating sides of the integrated energy system, based on an operation cost of each component in the current period and power purchase cost of a power grid;
using an actual utilization power of the renewable energy nodes, a power purchased from the power grid, and electric and thermal power outputs of each component in the current period as decision variables at the power and heat generating sides, and optimizing dispatching strategies with a target of minimizing the second objective function to obtain dispatching strategies on the power and heat generating sides; and
determining dispatching strategies of the power storage components, the heat storage components and the loads, based on the dispatching strategies on the power and heat generating sides.

Optionally, constraints of the second objective function comprise at least one of the following:
the feasibility constraints of the integrated energy system;
the thermal power output of the heat generating components satisfying the heat generation model of the heat generating components;
the electric power output of the power generating components satisfying the power generation model of the power generating components;
the thermal power output of the combined heat and power generating components satisfying the heat generation model of the combined heat and power generating components, and the electric power output of the combined heat and power generating components satisfying the power generation model of the combined heat and power generating components;
the power purchased from the power grid being greater than or equal to 0; or
the actual utilization power of the renewable energy nodes in the current period being greater than or equal to 0, and less than or equal to observed output power of the renewable energy nodes in the current period.

In another aspect, a dispatching device for an integrated energy system is provided according to at least one of the embodiments of the present disclosure. The device comprises:
first constructing module configured to construct a component power model for each component of the integrated energy system, and construct a system model of the integrated energy system according to the component power models and power(s) at renewable energy nodes, wherein the component comprises one or more of the following: a heat generating component, a power generating component, a combined heat and power generating component, a power storage component, a heat storage component and a load, and the load includes at least one of a fixed thermal load, a fixed electrical load or a deferrable electrical load;
first optimizing module configured to optimize a flexibility of the integrated energy system to obtain flexibility optimization results, by utilizing the system model and predicted data from the renewable energy nodes;
first determining module configured to determine feasibility constraints of the integrated energy system according to the flexibility optimization results; and
dispatching module configured to use the feasibility constraints and an operation cost of the integrated energy system as constraints and an optimization target respectively, and implement a real-time dispatching of the integrated energy system with real-time data from the renewable energy nodes.

Optionally, the first constructing module is further configured to construct the component power model for each component of the integrated energy system, which comprises one or more of the following:
construct a heat generation model based on a thermal power output for the heat generating component;
construct a power generation model based on an electric power output for the power generating component;
construct a power generation model based on an electric power output and a heat generation model based on a thermal power output for the combined heat and power generating component;
construct an electric energy model based on charging and discharging powers for the power storage component;
construct a thermal energy model based on heat storage charging and discharging powers for the heat storage component;
construct an electrical load model based on a fixed electric power for the fixed electrical load;
construct a total power relaxation model based on a deferrable electric power for the deferrable electrical load; or
constructing a heat load model based on a fixed heat power for the fixed heat load.

Optionally, the first constructing module is further configured to:
construct a real-time power balance model of electric energy of the integrated energy system according to the power(s) of the renewable energy nodes and electric powers of the components existing in the integrated energy system, wherein the electric powers include: an electric power output of the power generating components, an electric power output of the combined heat and power generating components, charging and discharging powers of the power storage components, a fixed electric power of the fixed electrical loads, or a deferrable electric power of the deferrable electrical loads; and,
construct a real-time power balance model of thermal energy of the integrated energy system according to thermal powers of the components existing in the integrated energy system, wherein the thermal powers include: a thermal power of the heat generating components, a thermal power of the combined heat and power generating components, thermal storage charging and discharging powers of the thermal storage components, or a fixed thermal power of the fixed thermal loads.

Optionally, the first optimizing module is further configured to:
represent the power of the renewable energy nodes as a function of the electric powers of the components of the integrated energy system, according to the real-time power balance model of the electric energy of the integrated energy system;
quantitatively characterize the flexibility of the integrated energy system in each time period as a difference between upper and lower limits of the power of the renewable energy nodes in the time period;
construct a first objective function of the flexibilities of the integrated energy system in multiple time periods, according to the upper and lower limits of the flexibility of the integrated energy system in each time period, wherein the first objective function aims to maximize the flexibility and evenly distribute it in the multiple time periods; and perform an optimization calculation to obtain the system flexibility optimization results, based on the first objective function; wherein constraints of the first objective function include:
upper and lower limits of power output of each component of the integrated energy system in each time period satisfying the component power model corresponding to the component;
the upper and lower limits of the flexibility of the integrated energy system in each time period corresponding to the upper and lower limits of the power output of the component of the integrated energy system in the time period, respectively;
relative constraints of renewable energy; or
relative conditions of feasibility.

Optionally, the first determining module is further configured to:
obtain upper and lower limits of outputs of the components of the integrated energy system in each time period, according to the flexibility optimization results;
determine upper and lower limits of a power of electric power supply and upper and lower limits of a power of thermal power supply of the integrated energy system, according to the upper and lower limits of the outputs of the components of the integrated energy system in each time period;
set feasibility constraints of electric power supply, according to the upper and lower limits of the power of electric power supply of the integrated energy system, wherein the electric power supply of the integrated energy system includes: actual utilization power of renewable energy nodes running in real time in the current period, power purchased from a power grid in the current period, or electrical power output of each component running in real time in the current period; and
set feasibility constraints of thermal power supply, according to the upper and lower limits of the power of thermal power supply of the integrated energy system, wherein the thermal power supply of the integrated energy system includes: thermal power output of each component running in real time in the current period.

Optionally, the dispatching module is further configured to:
construct a second objective function of operation costs of power and heat generating sides of the integrated energy system, based on an operation cost of each component in the current period and power purchase cost of a power grid;
use an actual utilization power of the renewable energy nodes, a power purchased from the power grid, and electric and thermal power outputs of each component in the current period as decision variables at the power and heat generating sides, and optimize dispatching strategies with a target of minimizing the second objective function to obtain dispatching strategies on the power and heat generating sides; and
determine dispatching strategies of the power storage components, the heat storage components and the loads, based on the dispatching strategies on the power and heat generating sides.

In another aspect, a computer-readable storage medium is provided according to at least one of the embodiments of the present disclosure, on which a program is stored, when the program is executed by a processor, the steps of the method described above are implemented.

Compared with the prior art, the dispatching method and device for the integrated energy system according to the embodiments of the present disclosure constructs an integrated energy system model and simplified component models, performs a rough optimization of a system flexibility with predicted data from renewable energy nodes; determines feasibility constraints according to flexibility optimization results; finally considers operation costs on power and heat generating sides, and implements a real-time dispatching with real-time data from the renewable energy nodes; and effectively combines day-ahead scheduling and real-time dispatching by fully utilizing the system flexibility to reduce impacts of prediction errors and achieves strong optimality.

### BRIEF DESCRIPTION OF THE DRAWINGS

Various other advantages and benefits will become apparent to those of ordinary skilled in the art by reading the detailed description of the preferred embodiments below. The accompanying drawings are only for the purpose of illustrating the preferred embodiments and are not considered as limiting the present disclosure. Also, the same reference symbols refer to the same elements throughout the accompanying drawings. In the accompanying drawings:

FIG. 1 is a schematic diagram of an integrated energy system that can be applied in embodiments of the present disclosure;

FIG. 2 is a flow chart of a dispatching method for an integrated energy system according to an embodiment of the present disclosure;

FIG. 3 is an exemplary diagram of an optimization result of system flexibility according to an embodiment of the present disclosure;

FIG. 4 is an example diagram of upper and lower limits of charging power of power storage components according to an embodiment of the present disclosure;

FIG. 5 is an example diagram of upper and lower limits of charging power of heat storage components according to an embodiment of the present disclosure;

FIG. 6 is an example diagram of upper and lower limits of an output of cogeneration units according to an embodiment of the present disclosure;

FIG. 7 is an example diagram of upper and lower limits of an output of boilers according to an embodiment of the present disclosure;

FIG. 8 is an example diagram of upper and lower limits of an output of deferrable electrical loads according to an embodiment of the present disclosure;

FIG. 9 is an example diagram of upper and lower limits of feasibility constraints at power supply side nodes according to an embodiment of the present disclosure;

FIG. 10 is an example diagram of upper and lower limits of feasibility constraints at heat supply side nodes according to an embodiment of the present disclosure;

FIG. 11 is an example diagram of calculation results of upper and lower limits of feasibility constraints at power supply side nodes according to an embodiment of the present disclosure;

FIG. 12 is an example diagram of calculation results of upper and lower limits of the feasibility constraints at heat supply side nodes according to an embodiment of the present disclosure;

FIG. 13 is an example diagram of a real-time dispatching result of an integrated energy system according to an embodiment of the present disclosure;

FIG. 14 is another example diagram of a real-time dispatching result of an integrated energy system according to an embodiment of the present disclosure;

FIG. 15 is an exemplary diagram of a dispatching device for an integrated energy system according to an embodiment of the present disclosure; and

FIG. 16 is another schematic structure diagram of a dispatching device for an integrated energy system according to an embodiment of the present disclosure.

### DETAILED DESCRIPTION

The exemplary embodiments of the present disclosure will be described in more detail below with reference to the accompanying drawings. Although the exemplary embodiments of the present disclosure are illustrated in the accompanying drawings, it should be understood that the present disclosure can be implemented in various forms and should not be limited by the embodiments set forth herein. On the contrary, these embodiments are provided in order to enable a more thorough understanding of the present disclosure and to fully convey the scope of the present disclosure to those skilled in the art.

It should be understood that, “one embodiment” or “an embodiment” mentioned throughout the specification means that the specific features, structures or characteristics related to the embodiment are included in at least one embodiment of the present disclosure. Therefore, “in one embodiment” or “in an embodiment” appearing throughout the specification may not necessarily refer to the same embodiment. In addition, these specific features, structures or characteristics can be combined in one or more embodiments in any suitable manner. The terms “first”, “second”, etc. in the description and claims of the present disclosure are used to distinguish similar objects, and are not necessarily used to describe a specific order or sequence. It should be understood that the data used in this way can be interchangeable where appropriate, so that the embodiments of the present disclosure described here can be implemented in an order other than those illustrated or described herein. In addition, the terms “including” and “having” and any of their variations are intended to cover non-exclusive inclusions, for example, processes, methods, systems, products or devices that include a series of steps or units are not necessarily limited to those steps or units that are clearly listed, but may include other steps or units that are not clearly listed or inherent to these processes, methods, products or devices. “And/or” in the description and claims represents at least one of the connected objects. In this disclosure, the upper bound and the upper limit have the same meaning, both refer to the maximum value of a parameter within a certain period of time; similarly, the lower bound and the lower limit have the same meaning, both refer to the minimum value of a parameter within a certain period of time.

In the various embodiments of the present disclosure, it should be understood that the numbering of the following processes does not mean the order of execution. The execution order of each process should be determined by its function and internal logic, and should not constitute any limitation on the implementation of the embodiments of the present disclosure.

The following description provides examples and does not limit the scope, applicability, or configuration set forth in the claims. Variations may be made to the functions and arrangements of the elements discussed without departing from the spirit and scope of the present disclosure. Various procedures or components may be appropriately omitted, replaced, or added in various examples. For example, the described methods may be performed in an order different from that described, and various steps may be added, omitted, or combined. In addition, features described with reference to certain examples may be combined in other examples.

The embodiments of the present disclosure can be applied to a method for day-ahead scheduling and real-time dispatching of an integrated energy system. Feasibility constraints are obtained by maximizing a system flexibility with day-ahead fuzzy prediction, and a real-time dispatching of the system is implemented by comprehensively considering operation costs of power and heat generation sides. According to an embodiment of the present disclosure, a flexibility-based method for day-ahead scheduling and real-time dispatching of an integrated energy system is provided. The method specifically includes: constructing an integrated energy system model and simplified component models; performing a rough optimization of a system flexibility with predicted data from renewable energy nodes; obtaining feasibility constraints based on system flexibility optimization results; considering operation costs of power and heat production sides, implementing a real-time dispatching with real-time data from the renewable energy nodes. A feasibility of the real-time dispatching is proved.

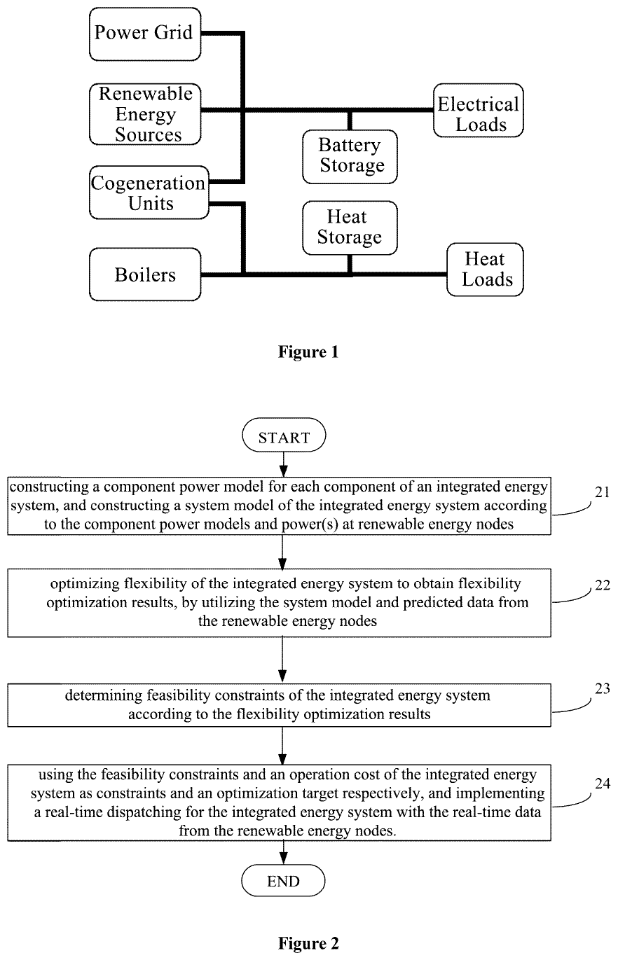

FIG. 1 illustrates a schematic diagram of an integrated energy system that can be applied in the embodiments of the present disclosure, which mainly includes: cogeneration units, boilers, power storage components (such as battery storage), heat storage components and loads, wherein the loads can be categorized into electrical loads and thermal loads, and the electrical loads can be further categorized into fixed loads (fixed electrical loads) and deferrable loads (deferrable electrical loads). In the embodiments of the present disclosure, the above constituent parts are also referred as components of the integrated energy system. In FIG. 1, the electrical loads, the battery storage devices, a power grid, renewable energy sources and the cogeneration units are connected through power lines. The power grid, the renewable energy sources and the cogeneration units provide power to the electrical loads and the power storage components (such as battery storage) through power lines, and the power storage components (such as battery storage) can also provide power to the electrical loads. The cogeneration units, the boilers, the heat storage components and the thermal loads are connected through heat pipelines. The cogeneration units, the boilers and the heat storage components provide heat to the thermal loads through the heat pipelines.

Referring to FIG. 2, a dispatching method for an integrated energy system is provided according to an embodiment of the present disclosure. The dispatching method includes:

Step 21: constructing a component power model for each component of an integrated energy system, and constructing a system model of the integrated energy system according to the component power models and power(s) at renewable energy nodes, wherein the component comprises one or more of the following: a heat generating component, a power generating component, a combined heat and power generating component, a power storage component, a heat storage component and a load, and the load includes at least one of a fixed thermal load, a fixed electrical load or a deferrable electrical load.

The components include a cogeneration unit, a boiler, a power storage component, a heat storage component and a load, wherein the load includes a fixed heat load, a fixed electrical load or a deferrable electrical load.

Herein, a heat generating component refers to a component that generates heat separately and provides the heat to loads in the integrated energy system, such as a boiler; a power generating component refers to a component that generates electricity separately and provides the electricity to loads in the integrated energy system, such as a diesel engine; a combined heat and power generating component refers to a component that can generate both heat and electricity and provide both the heat and the electricity to loads in the integrated energy system, such as a cogeneration unit. A system model of an integrated energy system and simplified component models are proposed according to an embodiment of the present disclosure. The system model integrates models of various cogeneration units, boilers, power storage components, heat storage components and loads in the integrated energy system. A relaxation model of a deferrable electrical load is also proposed.

Specifically, in step 21, the constructing the component power model for each component of the integrated energy system specifically includes one or more of the following:
constructing a heat generation model based on a thermal power output for the heat generating component;
constructing a power generation model based on an electric power output for the power generating component;
constructing a power generation model based on an electric power output and a heat generation model based on a thermal power output for the combined heat and power generating component;
constructing an electric energy model based on charging and discharging powers for the power storage component;
constructing a thermal energy model based on heat storage charging and discharging powers for the heat storage component;
constructing an electrical load model based on a fixed electric power for the fixed electrical load;
constructing a total power relaxation model based on a deferrable electric power for the deferrable electrical load; or
constructing a heat load model based on a fixed heat power for the fixed heat load.

The respective explanations are as follows.

### (0) Power Generating Component Model

A power generating component generates electricity through means such as combustion of fuels. A model of the power generating component can be expressed as:

$$\begin{matrix}{H}_{g e n}^{min} \leq {h}_{g e n} ( t ) \leq {H}_{g e n}^{max} , & t = 1 , 2 , … , T\end{matrix} \qquad ( 0 )$$

In the above formula, h_{gen} is an electric power output of a power generating component in a time period of t; H_{gen}^{max} and H_{gen}^{min} are upper and lower limits of the electric power output of the power generating component. Formula (0) is a power generation model of the power generating component.

### (1) Combined Heat and Power Generating Component Model (Such as Cogeneration Unit Model)

A combined heat and power generating component (such as a cogeneration unit) is a facility that utilizes heat engines or power stations to generate both electricity and heat simultaneously. In general power plants, the excess heat from a power generation process is mainly released to the environment through cooling towers or cooling water, while in cogeneration plants, the heat can be recovered and applied to residential users, commercial and industrial users. The combined heat and power generating component (such as a cogeneration unit) typically comprise a gas turbine-based cogeneration unit, an internal combustion engine-based cogeneration unit and a steam turbine-based cogeneration unit. According to respective operating characteristics, the combined heat and power generating components can be roughly divided into two types: a first type is a cogeneration unit composed of gas turbine engines and internal combustion engines (such as a gas turbine-based cogeneration unit and an internal combustion engine-based cogeneration unit). Amounts of heat and power generation of this type of cogeneration unit can be expressed by a linear function:

$$\begin{matrix}{h}_{C H P} ( t ) = {r}_{h p} {p}_{CHP} ( t ) , & t = 1 , 2 , … , T\end{matrix} \qquad ( 1 )$$

$$\begin{matrix}{P}_{C H P}^{min} \leq {p}_{C H P} ( t ) \leq {P}_{CHP}^{max} , & t = 1 , 2 , … , T\end{matrix} \qquad ( 2 )$$

In the above formula, h_{CHP}(t) and p_{CHP}(t) are thermal and electric power outputs of a combined heat and power generating component (such as a cogeneration unit) in a time period of t; rₕₚ is a power-to-heat ratio of the combined heat and power generating component (such as a cogeneration unit); P_{CHP}^{max} and P_{CHP}^{min} are upper and lower limits of the electric power output; T is the number of time periods. Formulas (1) and (2) are a power generation model and a heat generation model of the first type of combined heat and power generating component, respectively.

A second type is an extraction condensing cogeneration unit (such as a steam turbine-based cogeneration unit), which mainly uses the waste heat from a steam turbine. Its feasible operating area is a polyhedron with several extreme points. Power and heat outputs of this type of cogeneration unit can be expressed by a convex combination of extreme points:

$${p}_{C H P} ( t ) = {\sum }_{k} {S}^{k} ( t ) {P}_{C H P}^{k} \qquad ( 3 )$$

$${h}_{C H P} ( t ) = {\sum }_{k} {S}^{k} ( t ) {H}_{C H P}^{k} \qquad ( 4 )$$

In the above formula, P_{CHP}^{k} and H_{CHP}^{k} are amounts of heat and power generation of the extreme points, respectively; the parameter S^{k}(t) satisfies

$${\sum }_{k} {S}^{k} ( t ) = 1$$

and 0≤S^{k}(t)≤1; and k represents the number of extreme points. Formulas (3) and (4) are a power generation model and a heat generation model of the second type of combined heat and power generating component, respectively.

Regardless of the type of combined heat and power generating component, constraints on both heat and power generation are linear and time-independent. The embodiments of the present disclosure are applicable to two types of models. The following content takes the first type of cogeneration unit as an example.

### (2) Heat Generating Component Model (Such as Boiler Model)

A heat generating component (such as a boiler) generates heat by burning fuel or consuming electricity. A model of the heat generating component can be expressed as:

$$\begin{matrix}{H}_{B o i l}^{min} \leq {h}_{B o i l} ( t ) \leq {H}_{B o i l}^{max} , & t = 1 , 2 , … , T\end{matrix} \qquad ( 5 )$$

In the above formula, h_{Boil}(t) is a thermal power output of a heat generating component in a time period of t; H_{Boil}^{max} and H_{Boil}^{min} are upper and lower limits of the thermal power output of the heat generating component, respectively. Formula (5) is a heat generation model of the heat generating component.

### (3) Power Storage Component Model

A power storage component, such as battery storage, is one of the fastest-responding power storage devices currently available. Battery storage devices can typically output electricity for several hours at a full rated power. The battery storage devices can be used for short-term peak power and auxiliary services, such as providing operating reserves and frequency control. Due to high charge-discharge efficiency of the battery storage devices, it can be considered ideal in a real-time operation. A model of a battery storage device can be expressed as:

$$\begin{matrix}- {P}_{B}^{max} \leq {p}_{B} ( t ) \leq {P}_{B}^{max} , & t = 1 , 2 , … , T\end{matrix} \qquad ( 6 )$$

$$\begin{matrix}{E}_{B}^{min} \leq {E}_{B} ( t ) \leq {E}_{B}^{max} , & t = 1 , 2 , … , T\end{matrix} \qquad ( 7 )$$

$$\begin{matrix}{E}_{B} ( t ) = ( 1 - {σ}_{B} ) {E}_{B} ( t - 1 ) + {p}_{B} ( t ) Δ t , & t = 2 , … , T\end{matrix} \qquad ( 8 )$$

In the above formulas, p_{B}(t) is charging and discharging powers of a power storage component in a time period of t, which can be positive or negative, corresponding to charging and discharging conditions, respectively; E_{B}(t) is an electric power of the power storage component in a time period of t; P_{B}^{max} is the rated power of the power storage component; E_{B}^{max} and E_{B}^{min} are upper and lower limits of a capacity of the power storage component, respectively; σ_{B} is a self-discharge coefficient of the power storage component; Δt is a duration of the time period t. Formulas (6) to (8) is an electric energy model of the power storage component.

### (4) Heat Storage Component Model

Heat storage is a technology that allows thermal energy (i.e. heat) to be captured and stored for future use. Since thermal energy is easier to store than electric energy, energy systems can facilitate a balance of supply and demand of electricity by heat storage, which works similar to battery storage. Similarly, a charge-discharge efficiency of heat storage is very high and can also be considered ideal. A model of a heat storage component can be expressed as:

$$\begin{matrix}- {P}_{H}^{max} \leq {h}_{H} ( t ) \leq {P}_{H}^{max} , & t = 1 , 2 , … , T\end{matrix} \qquad ( 9 )$$

$$\begin{matrix}{E}_{H}^{min} \leq {E}_{H} ( t ) \leq {E}_{H}^{max} , & t = 1 , 2 , … , T\end{matrix} \qquad ( 10 )$$

$$\begin{matrix}{E}_{H} ( t ) = ( 1 - {σ}_{H} ) {E}_{H} ( t - 1 ) + {h}_{H} ( t ) Δ t , & t = 2 , … , T\end{matrix} \qquad ( 11 )$$

In the above formulas, h_{H}(t) is charge and discharge powers of a heat storage component in a time period of t, which can be positive or negative, corresponding to the storage and release of heat respectively; E_{H}(t) is a thermal power of the heat storage component in the time period of t; P_{H}^{max} is the rated power of the heat storage component; E_{H}^{max} and E_{H}^{min} are upper and lower limits of the capacity of heat storage component, respectively; σ_{H} is a self-loss coefficient of the heat storage component. Formulas (9) to (11) is a thermal energy model of the heat storage component.

### (5) Load Model

The electrical loads in the integrated energy system can be roughly divided into two categories: fixed loads and deferrable loads. The fixed loads p_{L}(t) are usually not affected by changes in external conditions or user behavior, have fixed change characteristics, and their power can be modeled as deterministic loads based on historical data. For example, motor loads, lighting loads, and industrial pump loads are typical fixed loads in a power system. Deferrable loads refer to electrical loads that can be shifted without impact on the quality of service they provide. The powers of such loads are usually fixed, but the power in each period can be adjusted and shifted. Typical examples are electric water heaters and certain specific types of industrial machinery. By shifting these loads to periods when overall electricity demand is lower, the power system can better balance the supply and demand of electricity, thereby improving reliability and reducing costs. This process is also commonly referred to as a demand-side response. A deferrable load is described as follows:

$$\begin{matrix}{P}_{D}^{min} ( t ) \leq {p}_{D} ( t ) \leq {P}_{D}^{max} ( t ) , & t = 1 , 2 , … , T\end{matrix} \qquad ( 12 )$$

$$\begin{matrix}{P}_{D} \leq {\sum }_{t = 1}^{T} {p}_{D} ( t ) Δ t \leq ( 1 + {r}_{D} ) {P}_{D} , & t = 1 , 2 , … , T\end{matrix} \qquad ( 13 )$$

In the above formulas, p_{D}(t) is a power of a deferrable load in a time period of t, P_{D}^{max}(t) and P_{D}^{min}(t) are upper and lower limits of the power of the deferrable load in the corresponding time period respectively; P_{D} is a total power of the deferrable load, r_{D} is a relaxation coefficient, indicating that a upper limit that the total power can reach. This is because in actual operation, it is extremely difficult to strictly guarantee a certain power, so a relatively relaxed constraint is set herein. Formulas (12)-(13) are a total power relaxation model of the deferrable electrical load.

The fixed electrical load in the integrated energy system is denoted as p_{L}(t).

The heat load h_{L}(t) in the integrated energy system is usually regarded as a fixed heat load, which is similar to the above mentioned fixed electrical load p_{L}(t), and will not be repeated herein.

### (6) Integrated Energy System Model

In actual operation, an integrated energy system needs to ensure a real-time power balance of electricity and heat.

In an embodiment of the present disclosure, a real-time power balance model of electric energy of the integrated energy system is constructed according to power(s) of the renewable energy nodes and electric powers of the components existing in the integrated energy system, wherein the electric powers include: the electric power output of the power generating components, the electric power output of the combined heat and power generating components, the charging and discharging powers of the power storage components, a fixed electric power of the fixed electrical loads, or a deferrable electric power of the deferrable electrical loads; and, a real-time power balance model of thermal energy of the integrated energy system is constructed according to thermal powers of the components existing in the integrated energy system, wherein the thermal powers include: the thermal power of the heat generating components, the thermal power of the combined heat and power generating components, the thermal storage charging and discharging powers of the thermal storage components, or a fixed thermal power of the fixed thermal loads.

Hereinafter, the integrated energy system shown in FIG. 1 will be mainly used as an example for explanation. The integrated energy system shown in FIG. 1 does not include the power generating components described above, but includes the combined heat and power generating components, i.e., the cogeneration units.

In an embodiment of the present disclosure, the real-time power balance model of the electric energy of the integrated energy system is constructed according to the power(s) of the renewable energy nodes, the electric power output of the cogeneration units, the charge and discharge powers of the power storage components, the fixed power of the fixed electrical loads, and the deferrable power of the deferrable electrical loads; and the real-time power balance model of the thermal energy of the integrated energy system is constructed according to the thermal power output of the cogeneration units, the thermal power output of the boilers, the heat storage charge and discharge powers of the heat storage components, and the fixed heat power of the fixed heat loads. The details are as follows:

$$\begin{matrix}{p}_{R} ( t ) + {p}_{C H P} ( t ) = {p}_{B} ( t ) + {p}_{D} ( t ) + {p}_{L} ( t ) , & t = 1 , 2 , … , T\end{matrix} \qquad ( 14 )$$

$$\begin{matrix}{h}_{C H P} ( t ) + {h}_{Boil} ( t ) = {h}_{H} ( t ) + {h}_{L} ( t ) , & t = 1 , 2 , … , T\end{matrix} \qquad ( 15 )$$

In the above formulas, p_{R}(t) is a renewable energy utilization power in a time period of t. Formulas (14) and (15) are real-time power balance models of electric energy and thermal energy of the integrated energy system respectively.

Step 22: optimizing flexibility of the integrated energy system to obtain flexibility optimization results, by utilizing the system model and predicted data from the renewable energy nodes.

Herein, in step 22, a scheme for performing a rough optimization of a system flexibility with predicted data from renewable energy nodes is proposed according to an embodiment of the present disclosure. With a rough prediction curve of day-ahead renewable energy output, the scheme fully utilizes the system flexibility, constructs a quadratic convex optimization problem, and calculates the system's ability to cope with uncertainties of the renewable energy output. The system flexibility is maximized and evenly distributed in each time period. Relative constraints of renewable energy in the optimization problem ensures that an ability to cope with the uncertainties of the renewable energy output should be distributed within a possible range of the renewable energy output; relative conditions of feasibility in the optimization problem ensures a feasibility of the following real-time dispatching.

Details are as follows.
1) The power of the renewable energy nodes is expressed as a function of the electric power of the components of the integrated energy system, according to the real-time power balance model of the electric energy of the integrated energy system. Herein, the integrated energy system is regarded as a whole, and its uncertainties mainly comes from the renewable energy nodes. According to the power balance, the expression of the power of renewable energy nodes can be obtained as:

$$\begin{matrix}{p}_{0} ( t ) = - {p}_{C H P} ( t ) + {p}_{B} ( t ) + {p}_{D} ( t ) + {p}_{L} ( t ) , & t = 1 , 2 , … , T\end{matrix} \qquad ( 16 )$$

2) The flexibility of the integrated energy system in each time period is quantitatively characterized as a difference between upper and lower limits of the power of the renewable energy nodes in the time period. The system flexibility is a ability to cope with the uncertainties of the renewable energy output. In an embodiment of the present disclosure, it is hoped that the system will be as flexible as possible in order to cope with a fluctuation of the renewable energy output in a wide range; on the other hand, it is hoped that the system flexibility will be evenly distributed in every time period, because uncertainties exists in every time period. Therefore, in an embodiment of the present disclosure, the system flexibility in each time period is quantitatively characterized as the difference between upper and lower limits of the renewable energy output that can be coped with, p₀^{up}(t)−p₀^{low}(t).

Similarly, in each period, output powers of the components in the system also have upper limits and lower limits, which are expressed as:

$${x}^{u p} = \{ {p}_{C H P}^{u p} , {p}_{B}^{u p} , {p}_{D}^{u p} , {h}_{CHP}^{up} , {h}_{B oil}^{up} , {h}_{H}^{u p} \} \qquad ( 17 )$$

$${x}^{l o w} = \{ {p}_{C H P}^{l o w} , {p}_{B}^{l o w} , {p}_{D}^{l o w} , {h}_{C H P}^{l o w} , {h}_{B o i l}^{l o w} , {h}_{H}^{l o w} \} \qquad ( 18 )$$

The system flexibility is composed of flexibility of each internal component. In other words, a upper limit of a power output of each component corresponds to a upper limit of the system flexibility, and a lower limit of the power output of each component corresponds to a lower limit of the system flexibility, that is:

$$\begin{matrix}{p}_{0}^{up} ( t ) = - {p}_{C H P}^{u p} ( t ) + {p}_{B}^{u p} ( t ) + {p}_{D}^{u p} ( t ) + {p}_{L} ( t ) , & t = 1 , 2 , … , T\end{matrix} \qquad ( 19 )$$

$$\begin{matrix}{p}_{0}^{low} ( t ) = - {p}_{C H P}^{low} ( t ) + {p}_{B}^{low} ( t ) + {p}_{D}^{low} ( t ) + {p}_{L} ( t ) , & t = 1 , 2 , … , T\end{matrix} \qquad ( 20 )$$

$$\begin{matrix}{h}_{C H P}^{u p} ( t ) + {h}_{Boil}^{u p} ( t ) = {h}_{H}^{u p} ( t ) + {h}_{L} ( t ) , & t = 1 , 2 , … , T\end{matrix} \qquad ( 21 )$$

$$\begin{matrix}{h}_{C H P}^{l o w} ( t ) + {h}_{B o i l}^{low} ( t ) = {h}_{H}^{l o w} ( t ) + {h}_{L} ( t ) , & t = 1 , 2 , … , T\end{matrix} \qquad ( 22 )$$

3) A first objective function of the flexibilities of the integrated energy system in multiple time periods is constructed, according to the upper and lower limits of the flexibility of the integrated energy system in each time period, wherein the first objective function aims to maximize the flexibility and evenly distribute it in the multiple time periods; an optimization calculation is performed to obtain system flexibility optimization results, based on the first objective function; wherein constraints of the first objective function include:
upper and lower limits of power output of each component of the integrated energy system in each time period satisfying the component power model corresponding to the component, which corresponds to x^{up}, x^{low} in formula (23) satisfying the formulas (1)-(13);
the upper and lower limits of the flexibility of the integrated energy system in each time period corresponding to the upper and lower limits of the power outputs of the components of the integrated energy system in the time period, respectively, which corresponds to x^{up}, x^{low} in formula (23) satisfying the formulas (19)-(22);
the relative constraints of renewable energy, which corresponds to the following in the formula (23),

$$α {P}_{R} ( t ) \leq {p}_{0}^{u p} ( t ) \leq {P}_{R} ( t ) , 0 \leq {p}_{0}^{low} ( t ) \leq β {P}_{R} ( t ) , \qquad t = 1 , 2 , … , T$$

the relative conditions of the feasibility specifically include: the upper limit of the flexibility of the integrated energy system in each time period is greater than or equal to the lower limit of the flexibility of the integrated energy system in the time period; the upper limit of the output of each component of the integrated energy system in each time period is greater than or equal to the lower limit of the output of the component in the time period,
   corresponding to the following in formula (23)

$$\begin{matrix}{p}_{B}^{u p} ( t ) \geq {p}_{B}^{l o w} ( t ) , {p}_{D}^{u p} ( t ) \geq {p}_{D}^{l o w} ( t ) , {h}_{H}^{u p} ( t ) \leq {h}_{H}^{l o w} ( t ) , & t = 1 , 2 , … , T\end{matrix} , \begin{matrix}{p}_{0}^{u p} ( t ) \geq {p}_{0}^{l o w} ( t ) , & t = 1 , 2 , … , T\end{matrix}$$

In an embodiment of the present disclosure, it is hoped that the flexibility is as large as possible and evenly distributed in each time period. Therefore, an optimization calculation of the system flexibility can be expressed as:

$$max {\sum }_{t = 1}^{T} ( ( {p}_{0}^{u p} ( t ) - {p}_{0}^{l o w} ( t ) ) - {ω ( {p}_{0}^{u p} ( t ) - {p}_{0}^{l o w} ( t ) )}^{2} ) s . t . {x}^{u p} , {x}^{l o w} satisfying the formulas ( 1 ) - ( 13 ) , ( 19 ) - ( 22 ) {p}_{0}^{u p} ( t ) \geq {p}_{0}^{l o w} ( t ) , t = 1 , 2 , … , T α {P}_{R} ( t ) \leq {p}_{0}^{u p} ( t ) \leq {P}_{R} ( t ) , 0 \leq {p}_{0}^{l o w} ( t ) \leq β {P}_{R} ( t ) , t = 1 , 2 , … , T {p}_{B}^{u p} ( t ) \geq {p}_{B}^{l o w} ( t ) , {p}_{D}^{u p} ( t ) \geq {p}_{D}^{l o w} ( t ) , {h}_{H}^{u p} ( t ) \leq {h}_{H}^{l o w} ( t ) , t = 1 , 2 , … , T \qquad ( 23 )$$

In the above formulas, ω is a very small positive number, which is a constant related to the system and can be set based on experiences. Using a quadratic term as a variance can make the flexibility optimization results of the system evenly distributed. Independent variables at present are the upper and lower limits of the system flexibility and each component in each time period, that is, x^{up} and x^{low}. In addition to basic constraints of the components (1)-(13) and the power balance (19)-(22), the optimization calculation must also satisfy the relative constraints of renewable energy and several relative conditions of the feasibility to ensure the feasibility of the real-time dispatching, which will be proved later. Herein, only the relative constraints of renewable energy are explained.

In an embodiment of the present disclosure, the relative constraints of renewable energy include:
the upper limit of the flexibility of the integrated energy system in each time period being greater than or equal to a product of a first coefficient α and the power of a renewable energy node in the time period, and less than or equal to the power of a second renewable energy node in the time period; the lower limit of the flexibility of the integrated energy system in each time period being greater than or equal to 0, and less than or equal to a product of a second coefficient β and the power of the renewable energy node in the time period; where the first coefficient α and the second coefficient β are both preset positive numbers greater than 0 and less than 1. That is:

$$α {P}_{R} ( t ) \leq {p}_{0}^{u p} ( t ) \leq {P}_{R} ( t ) , 0 \leq {p}_{0}^{low} ( t ) \leq β {P}_{R} ( t ) , t = 1 , 2 , … , T \qquad ( 24 )$$

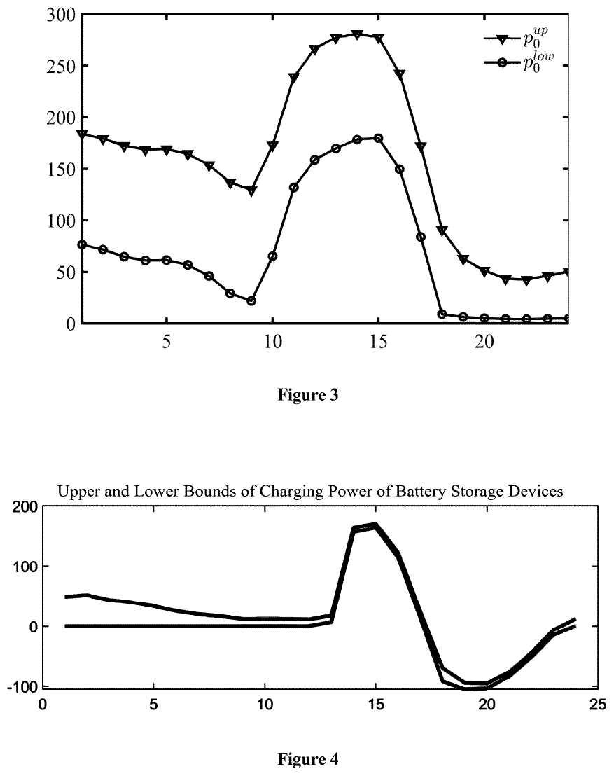

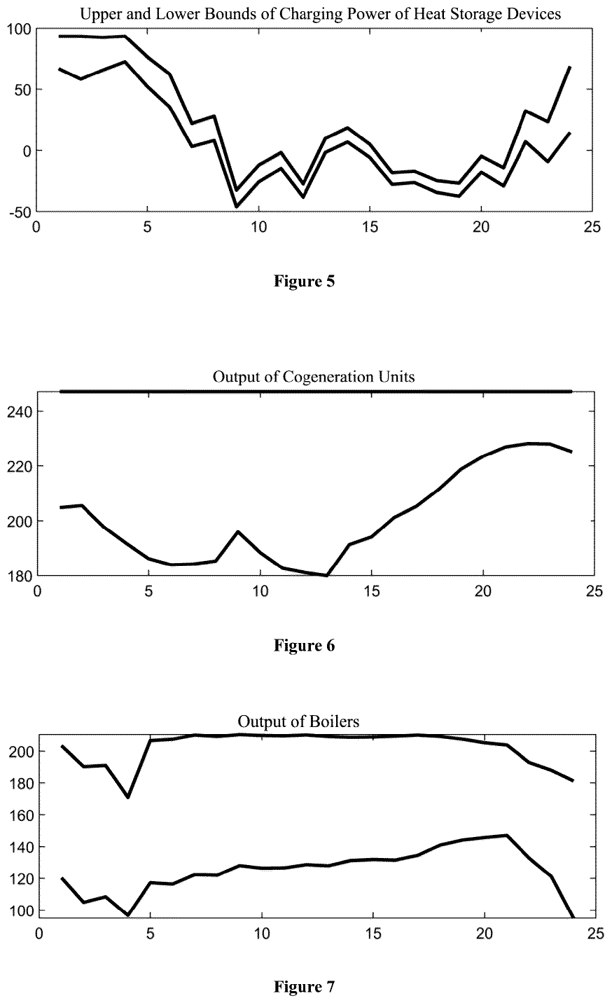

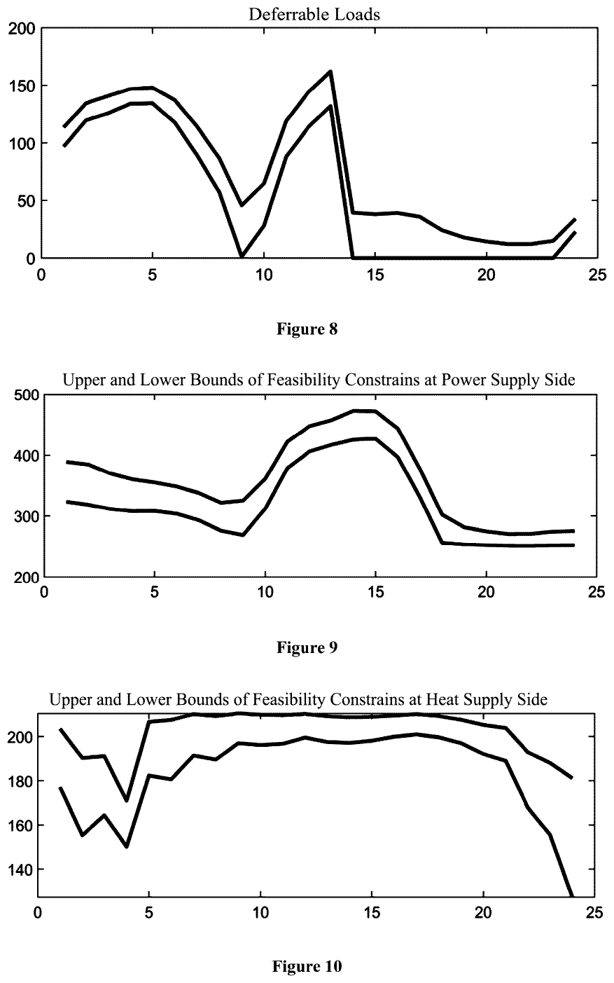

In the above formula, α and β are both given coefficients, P_{R}(t) is predicted values of the renewable energy output. This formula shows that the flexibility of the integrated energy system, that is, the ability to cope with the uncertainties of the renewable energy output, should be distributed within the possible range of the renewable energy output. The optimization results of the system flexibility are shown in FIG. 3. An area between a curve of p₀^{low} and a curve of p₀^{up} is the range of the system flexibility; An area between the curve of p₀^{up} and a straight line with the vertical ordinate of 0 is the possible range of the renewable energy output, the upper bound of which is predicted values of the total renewable energy output, and the lower bound is 0. FIGS. 4 to 10 show an example of the calculated results of the upper and lower limits of the power output of each component. Among them, FIG. 4 shows upper and lower limits of a charging power of power storage components (such as battery energy storage devices), FIG. 5 shows upper and lower limits of a charging power of heat storage components, FIG. 6 shows upper and lower limits of an output of cogeneration units, FIG. 7 shows upper and lower limits of an output of boilers, FIG. 8 shows upper and lower limits of an output of deferrable electrical loads, FIG. 9 shows upper and lower limits of feasibility constraints at power supply side nodes, and FIG. 10 shows upper and lower limits of feasibility constraints at heat supply side nodes.

Through the above steps, the upper and lower limits of the flexibility of the integrated energy system in each time period and the upper and lower limits of the output of the components of the integrated energy system in the time period can be calculated.

Step 23: Determining feasibility constraints of the integrated energy system according to the flexibility optimization results.

Herein, in step 23, the feasibility constraints are determined according to the system flexibility optimization results in an embodiment of the present disclosure. The feasibility constraints restrict upper and lower limits of powers at power supply side nodes and heat supply side nodes, which corresponding to limits of the system flexibility range. It is ensured that as long as the powers at the power supply nodes and the heat supply side nodes are within the corresponding upper and lower limits, there is always a real-time dispatching strategy that makes the system feasible. The power supply side nodes include a power grid, a renewable energy node, a cogeneration unit, etc., and the heat supply side nodes include a cogeneration unit, a boiler, etc.

Specifically, upper and lower limits of outputs of the components of the integrated energy system in each time period are obtained according to the flexibility optimization results in an embodiment of the present disclosure. Then, upper and lower limits of electric power output and upper and lower limits of thermal power output of the integrated energy system are determined according to the upper and lower limits of the outputs of the components of the integrated energy system in each time period.

For example, through the above optimization of the system flexibility, x^{up} and x^{low} can be obtained. Through x^{up} and x^{LOW}, upper and lower limits of powers at energy supply side nodes of the integrated energy system can further calculated. Among them, upper and lower limits of the powers at the power supply side nodes p_{b}^{up}(t) and p_{b}^{low}(t) are:

$${p}_{b}^{u p} ( t ) = {p}_{B}^{u p} ( t ) + {p}_{D}^{u p} ( t ) + {p}_{L} ( t ) , t = 1 , 2 , … , T \qquad ( 25 )$$

$${p}_{b}^{l o w} ( t ) = {p}_{B}^{l o w} ( t ) + {p}_{D}^{l o w} ( t ) + {p}_{L} ( t ) , t = 1 , 2 , … , T \qquad ( 26 )$$

upper and lower limits of the powers at the heat supply side nodes h_{b}^{up}(t) and h_{b}^{low}(t) are:

$${h}_{b}^{up} ( t ) = {h}_{H}^{up} ( t ) + {h}_{L} ( t ) , t = 1 , 2 , … , T \qquad ( 27 )$$

$${h}_{b}^{low} ( t ) = {h}_{H}^{low} ( t ) + {h}_{L} ( t ) , t = 1 , 2 , … , T \qquad ( 28 )$$

Then, feasibility constraints of electrical power supply are set, according to the upper and lower limits of electric power supply of the integrated energy system, wherein the power supply of the integrated energy system includes: actual utilization power of renewable energy nodes running in real time in the current period, power purchased from a power grid in the current period, and electrical power output of each component running in real time in the current period; and feasibility constraints of heat supply are set, according to the upper and lower limits of the thermal power output of the integrated energy system, wherein the heat supply of the integrated energy system includes: thermal power of boilers running in real time in the current period, or thermal power of each component running in real time in the current period.

For example, the upper and lower limits of powers at the power and heat supply side nodes obtained through the above flexibility optimization correspond to the limits of the system flexibility range. That is to say, as long as the powers at the power and heat supply side nodes are within the corresponding upper and lower limits, the system flexibility is allowed, and there is always a real-time dispatching strategy that makes the system feasible. This conclusion will be proved below. Therefore, feasibility constraints during a real-time operation can be obtained:

$${p}_{b}^{l o w} ( t ) \leq {p}_{r} ( t ) + {p}_{grid} ( t ) + {P}_{C H P} ( t ) \leq {P}_{b}^{u p} ( t ) \qquad ( 29 )$$

$${h}_{b}^{u p} ( t ) \leq {h}_{B o i l} ( t ) + {h}_{C H P} ( t ) \leq {h}_{b}^{l o w} ( t ) \qquad ( 30 )$$

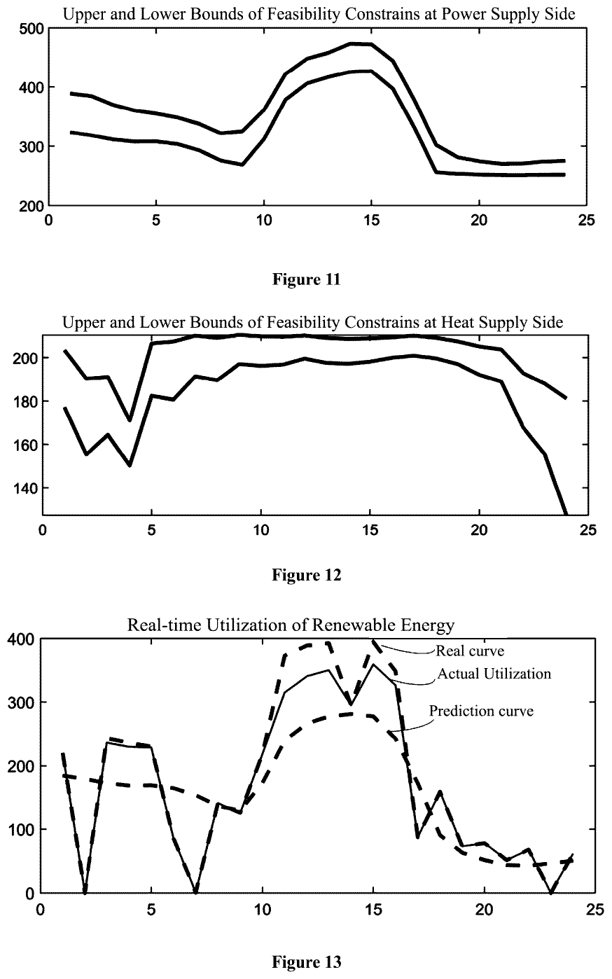

The above formula (29) is a feasibility constraint for power supply, and the above formula (30) is a feasibility constraint for heat supply. In the above formulas, pᵣ(t) is actual utilization power of renewable energy nodes running in real time in a time period of t; p_{grid}(t) is power purchased from power grid in the time period of t; p_{CHP}(t) is electric power output of cogeneration units running in real time in the time period of t; h_{Boil}(t) is thermal power output of boilers running in real-time in the time period t; h_{CHP}(1) is thermal power output of the cogeneration units running in real time in the time period t. FIG. 11 shows an example of calculation results of upper and lower limits of feasibility constraints at power supply side nodes, and FIG. 12 shows an example of calculation results of upper and lower limits of feasibility constraints at thermal energy supply side nodes.

Step 24: using the feasibility constraints and an operation cost of the integrated energy system as constraints and an optimization target respectively, the operation cost of the integrated energy system as the optimization target, and implementing a real-time dispatching of the integrated energy system with real-time data from the renewable energy nodes.

Herein, in step 24, considering operation costs of power and heat generating sides, the real-time dispatching is implemented with the real-time data from the renewable energy nodes in an embodiment of the present disclosure. The real-time dispatching has strong optimality and its feasibility can be fully proved. The power and heat generating sides include a power generating component, a combined heat and power generating component (such as a cogeneration unit), a heat generating component (such as a boiler), a power grid and other nodes.

Specifically, a second objective function of operation costs of power and heat generating sides of the integrated energy system is constructed based on an operation cost of each component in the current period and power purchase cost of the power grid in an embodiment of the present disclosure. For example, the second objective function of the operation costs of the power and heat generating sides of the integrated energy system is constructed, based on heating cost of boilers, power purchase cost of the power grid, and an operation cost of cogeneration units in the current period. The above-mentioned operation costs of power and heat generating sides are explained below.

The operation cost of the cogeneration units C_{CHP}(t) can be expressed as a quadratic function of the electric power output:

$${C}_{C H P} ( t ) = {ap}_{C H P}^{2} ( t ) + {bp}_{C H P} ( t ) + c \qquad ( 31 )$$

The heating cost of the boilers C_{Boiler}(t) is proportional to fuel consumption, so the cost can be viewed as a linear function of the thermal power output:

$${C}_{B o i l e r} ( t ) = θ {h}_{B o i l} ( t ) \qquad ( 32 )$$

The power purchase cost of the power grid C_{Grid}(t) is a linear function of amounts of electricity purchased:

$${C}_{Grid} ( t ) = γ {p}_{grid} ( t ) \qquad ( 33 )$$

In the above formulas, a, b, C are cost coefficients of the cogeneration units, all of which are positive numbers; θ is a heating cost coefficient of the boilers; and γ is unit electricity price.

Then, the actual utilization power of the renewable energy nodes, the power purchased from the power grid, and the electric and thermal power output of each component in the current period are used as decision variables at the power and heat generating sides, and a dispatching strategy is optimized with the goal of minimizing the second objective function to obtain the dispatching strategy on the power and heat generating sides. For example, the actual utilization power of the renewable energy nodes, the power purchased from the power grid, the thermal power output of the boilers, and the electric and thermal power output of the cogeneration units in the current period are used as the decision variables at the power and heat generating sides, and the dispatching strategy is optimized with the goal of minimizing the second objective function to obtain the dispatching strategy on the power and heat generating sides.

Then, dispatching strategies of the power storage components, the heat storage components and the loads are determined, based on the dispatching strategy on the power and heat generating sides. Here, constraints of the second objective function include at least one of the following:
the feasibility constraints of the integrated energy system;
the thermal power output of the heat generating components satisfying the heat generation model of the heat generating components;
the electric power output of the power generating components satisfying the power generation model of the power generating components;
the thermal power output of the combined heat and power generating components satisfying the heat generation model of the combined heat and power generating components, and the electric power output of the combined heat and power generating components satisfying the power generation model of the combined heat and power generating components;
the power purchased from the power grid being greater than or equal to 0; or
the actual utilization power of the renewable energy nodes in the current period being greater than or equal to 0, and less than or equal to observed output power of the renewable energy nodes in the current period.

For example, in a real-time dispatching, assuming that there is no accurate prediction of future renewable energy output, only an optimization problem of the power and heat generating sides involving the current period t is solved. At this time, the decision variables of the heat sides power and generating are γ(t)={p_{CHP}(t),h_{CHP}(t),h_{Boil}(t),p_{grid}(t), pᵣ(t)}.

The optimization problem of the real-time dispatching can be expressed as:

$$min {C}_{C H P} ( t ) + {C}_{boil} ( t ) + {C}_{g r i d} ( t ) s . t . ( 29 ) - ( 30 ) , y ( t ) satisfying formulas ( 1 ) - ( 5 ) {p}_{g r i d} ( t ) \geq 00 \leq {p}_{r} ( t ) \leq {p}_{R} ( t ) \qquad ( 34 )$$

In the above formulas, p_{R}(t) is actual output of renewable energy observed in a time period of t, and the actual utilization of renewable energy pᵣ(t) should be less than or equal to p_{R}(t) but greater than or equal to zero. According to the results of solving the formula (34), a real-time dispatching strategy on the power and heat generating sides y(t) can be obtained, while dispatching strategies on energy storage and load sides

z(t)={p_{B}(t),h_{H}(t),p_{D}(t)} can be given as follows:

$${λ}_{1} ( t ) = \frac{( {p}_{r} ( t ) + {p}_{g r i d} ( t ) + {p}_{C H P} ( t ) ) - {p}_{b}^{l o w} ( t )}{{p}_{b}^{u p} ( t ) - {p}_{b}^{l o w} ( t )} \qquad ( 35 )$$

$${λ}_{2} ( t ) = \frac{( {h}_{B o i l} ( t ) + {h}_{C H P} ( t ) ) - {h}_{b}^{l o w} ( t )}{{h}_{b}^{u p} ( t ) - {h}_{b}^{l o w} ( t )} \qquad ( 36 )$$

$${p}_{B} ( t ) = {λ}_{1} ( t ) {p}_{B}^{low} ( t ) + ( 1 - {λ}_{1} ( t ) ) {p}_{B}^{u p} ( t ) \qquad ( 37 )$$

$${h}_{H} ( t ) = {λ}_{2} ( t ) {h}_{H}^{l o w} ( t ) + ( 1 - {λ}_{2} ( t ) ) {h}_{H}^{up} ( t ) \qquad ( 38 )$$

$${p}_{D} ( t ) = {λ}_{1} ( t ) {p}_{D}^{low} ( t ) + ( 1 - {λ}_{1} ( t ) ) {p}_{D}^{u p} ( t ) \qquad ( 39 )$$

Obviously, 0≤λ₁(t)≤1, 0≤λ₂(t)≤1. A feasibility of the dispatching strategy is proved below. Since the decision variables on the power and heat generating sides y(t)={p_{CHP}(t), h_{CHP}(t), h_{Boil}(t), p_{grid}(t), pᵣ(t)} naturally satisfies system constraints, it must be feasible. The following only needs to prove that z(t)={p_{B}(t),h_{H}(t),p_{D}(t)} is always feasible. Taking battery storage as an example, the formula (8) can be expressed as follows:

$$E ( t ) = E ( 0 ) + {\sum }_{τ = 1}^{t} {( 1 - σ )}^{t - τ} p ( τ ) Δ t \qquad ( 40 )$$

The formula (7), in which are constraints of upper and lower limits of energy storage, can be summarized as:

$$\frac{{E}_{min} - E ( 0 )}{Δ t} \leq {\sum }_{τ = 1}^{t} {( 1 - σ )}^{t - τ} p ( τ ) Δ t \leq \frac{{E}_{max} - E ( 0 )}{Δ t} \qquad ( 41 )$$

Since p^{up}(t) and p^{low}(t) naturally satisfy the formula (7), the following can be obtained:

$$\frac{{E}_{min} - E ( 0 )}{Δ t} \leq {\sum }_{τ = 1}^{t} {( 1 - σ )}^{t - τ} {p}^{u p} ( τ ) Δ t \leq \frac{{E}_{max} - E ( 0 )}{Δ t} \qquad ( 42 )$$

$$\frac{{E}_{min} - E ( 0 )}{Δ t} \leq {\sum }_{τ = 1}^{t} {( 1 - σ )}^{t - τ} {p}^{l o w} ( τ ) Δ t \leq \frac{{E}_{max} - E ( 0 )}{Δ t} \qquad ( 43 )$$

According to the relative conditions of feasibility p_{B}^{up}(t)≥p_{B}^{low}(t) in the formula (23) and the formula (37), the following can be obtained:

$${\sum }_{τ = 1}^{t} {( 1 - σ )}^{t - τ} {p}_{B}^{l o w} ( τ ) \leq {\sum }_{τ = 1}^{t} {( 1 - σ )}^{t - τ} {p}_{B} ( τ ) \leq {\sum }_{τ = 1}^{t} {( 1 - σ )}^{t - τ} {p}_{B}^{u p} ( τ ) \qquad ( 44 )$$

Thus, the formula (41) is proved. Since heat storage has exactly the same form as battery storage, the proving process is not repeated herein.

For the deferrable loads, according to the relative conditions of feasibility p_{D}^{up}(t)≥p_{D}^{low}(t) in the formula (23) and the formula (39), the following can be obtained:

$${\sum }_{t = 1}^{T} {p}_{D}^{low} ( t ) \leq {\sum }_{t = 1}^{T} {p}_{D} ( t ) \leq {\sum }_{t = 1}^{T} {p}_{D}^{u p} ( t ) \qquad ( 45 )$$

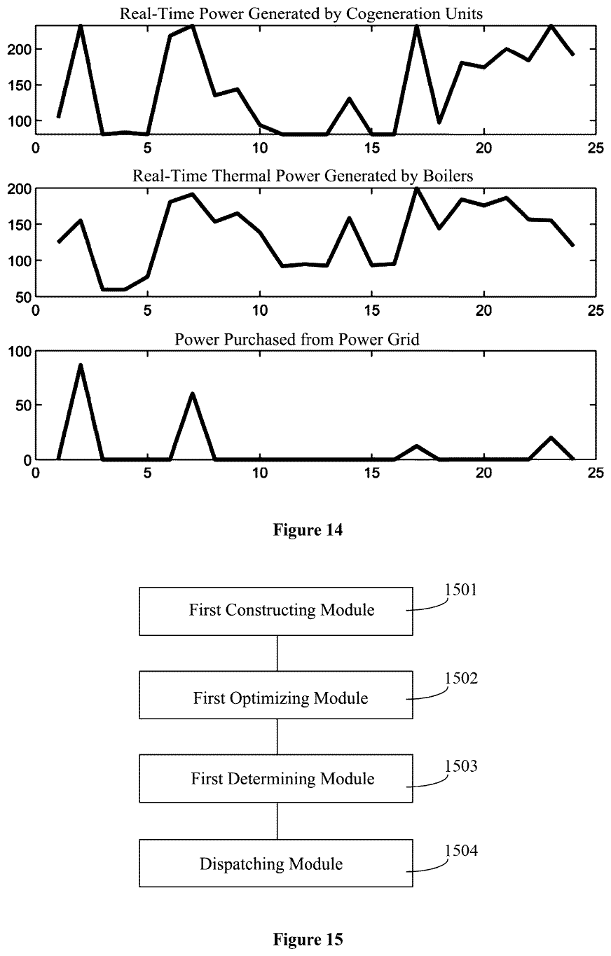

Obviously, the formula (13) is then proved. So far, the feasibility of the real-time dispatching of the system has been fully proved. Results of the real-time dispatching of the system are shown in FIGS. 13 and 14.

Referring to FIG. 15, a configuration of a dispatching device for an integrated energy system is provided according to an embodiment of the present disclosure. The device includes:
first constructing module 1501 configured to construct a component power model for each component of the integrated energy system, and construct a system model of the integrated energy system according to the component power models and power(s) at renewable energy nodes, wherein the component comprises one or more of the following: a heat generating component, a power generating component, a combined heat and power generating component, a power storage component, a heat storage component and a load, and the load includes at least one of a fixed thermal load, a fixed electrical load or a deferrable electrical load;
first optimizing module 1502 configured to optimize a flexibility of the integrated energy system to obtain flexibility optimization results, by utilizing the system model and predicted data from the renewable energy nodes;
first determining module 1503 configured to determine feasibility constraints of the integrated energy system according to the flexibility optimization results; and
dispatching module 1504 configured to use the feasibility constraints and an operation cost of the integrated energy system as constraints and an optimization target respectively, and implement a real-time dispatching of the integrated energy system with real-time data from the renewable energy nodes.

With the above modules, the device according to the embodiments of the present disclosure effectively combines day-ahead planning and real-time dispatching by utilizing system flexibility to reduce impacts of prediction errors, and achieves strong optimality.

Optionally, the first building module is further configured to construct the component power model for each component of the integrated energy system, which comprises one or more of the following:
construct a heat generation model based on a thermal power output for the heat generating component;
construct a power generation model based on an electric power output for the power generating component;
construct a power generation model based on an electric power output and a heat generation model based on a thermal power output for the combined heat and power generating component;
construct an electric energy model based on charging and discharging powers for the power storage component;
construct a thermal energy model based on heat storage charging and discharging powers for the heat storage component;
construct an electrical load model based on a fixed electric power for the fixed electrical load;
construct a total power relaxation model based on a deferrable electric power for the deferrable electrical load; or
construct a heat load model based on a fixed heat power for the fixed heat load.

Optionally, the first constructing modules is further configured to:
construct a real-time power balance model of electric energy of the integrated energy system according to the power(s) of the renewable energy nodes and electric powers of the components existing in the integrated energy system, wherein the electric powers include: an electric power output of the power generating components, an electric power output of the combined heat and power generating components, charging and discharging powers of the power storage components, a fixed electric power of the fixed electrical loads, or a deferrable electric power of the deferrable electrical loads; and,
construct a real-time power balance model of thermal energy of the integrated energy system according to thermal powers of the components existing in the integrated energy system, wherein the thermal powers include: a thermal power of the heat generating components, a thermal power of the combined heat and power generating components, thermal storage charging and discharging powers of the thermal storage components, or a fixed thermal power of the fixed thermal loads.

Optionally, the first optimizing modules is further configured to:
represent the power of the renewable energy nodes as a function of the electric powers of the components of the integrated energy system, according to the real-time power balance model of the electric energy of the integrated energy system;
quantitatively characterize the flexibility of the integrated energy system in each time period as a difference between upper and lower limits of the power of the renewable energy nodes in the time period;
construct a first objective function of the flexibilities of the integrated energy system in multiple time periods, according to the upper and lower limits of the flexibility of the integrated energy system in each time period, wherein the first objective function aims to maximize the flexibility and evenly distribute it in the multiple time periods; and perform an optimization calculation to obtain the system flexibility optimization results, based on the first objective function; wherein constraints of the first objective function include:
   upper and lower limits of power output of each component of the integrated energy system in each time period satisfying the component power model corresponding to the component;
   the upper and lower limits of the flexibility of the integrated energy system in each time period corresponding to the upper and lower limits of the power output of the component of the integrated energy system in the time period, respectively;
   relative constraints of renewable energy; or
   relative conditions of feasibility.

Optionally, the relative constraints of renewable energy comprise:
the upper limit of the flexibility of the integrated energy system in each time period being greater than or equal to a product of a first coefficient and the power of a renewable energy node in the time period, and less than or equal to the power of a second renewable energy node in the time period;
the lower limit of the flexibility of the integrated energy system in each time period being greater than or equal to 0, and less than or equal to a product of a second coefficient and the power of the renewable energy node in the time period; or
the first coefficient and the second coefficient are both preset positive numbers greater than 0 and less than 1.

Optionally, the relative conditions of the feasibility comprise:
the upper limit of the flexibility of the integrated energy system in each time period is greater than or equal to the lower limit of the flexibility of the integrated energy system in the time period; or
the upper limit of the output of each component of the integrated energy system in each time period is greater than or equal to the lower limit of the output of the component in the time period.

Optionally, the first determining module is further configured to:
obtain upper and lower limits of outputs of the components of the integrated energy system in each time period, according to the flexibility optimization results;
determine upper and lower limits of a power of electric power supply and upper and lower limits of a power of thermal power supply of the integrated energy system, according to the upper and lower limits of the outputs of the components of the integrated energy system in each time period;
set feasibility constraints of electric power supply, according to the upper and lower limits of the power of electric power supply of the integrated energy system, wherein the electric power supply of the integrated energy system includes: actual utilization power of renewable energy nodes running in real time in the current period, power purchased from a power grid in the current period, or electrical power output of each component running in real time in the current period; and
set feasibility constraints of thermal power supply, according to the upper and lower limits of the power of thermal power supply of the integrated energy system, wherein the thermal power supply of the integrated energy system includes: thermal power output of each component running in real time in the current period.

Optionally, the dispatching module is further configured to:
construct a second objective function of operation costs of power and heat generating sides of the integrated energy system, based on an operation cost of each component in the current period and power purchase cost of a power grid;
use an actual utilization power of the renewable energy nodes, a power purchased from the power grid, and electric and thermal power outputs of each component in the current period as decision variables at the power and heat generating sides, and optimizing dispatching strategies with a target of minimizing the second objective function to obtain dispatching strategies on the power and heat generating sides; and
determine dispatching strategies of the power storage components, the heat storage components and the loads, based on the dispatching strategies on the power and heat generating sides.

Optionally, constraints of the second objective function comprise at least one of the following:
the feasibility constraints of the integrated energy system;
the thermal power output of the heat generating components satisfying the heat generation model of the heat generating components;
the electric power output of the power generating components satisfying the power generation model of the power generating components;
the thermal power output of the combined heat and power generating components satisfying the heat generation model of the combined heat and power generating components, and the electric power output of the combined heat and power generating components satisfying the power generation model of the combined heat and power generating components;
the power purchased from the power grid being greater than or equal to 0; or
the actual utilization power of the renewable energy nodes in the current period being greater than or equal to 0, and less than or equal to observed output power of the renewable energy nodes in the current period.

It should be noted that various systems in the above embodiments are devices corresponding to the dispatching method for the integrated energy system, and the implementations in the above embodiments are applicable to the embodiments of the device, and can also achieve the same technical effects. The above device according to the embodiments of the present disclosure can implement all the method steps implemented in embodiments of the method, and can achieve the same technical effects. The parts and beneficial effects that are the same as those in the embodiments of the method will not be repeatedly described in detail here.

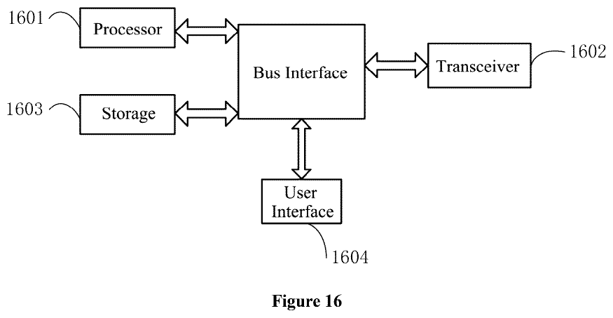

FIG. 16 illustrates a schematic structural diagram of another dispatching device of an integrated energy system according to an embodiment of the present disclosure. The device includes a processor 1601, a transceiver 1602, a storage 1603, a user interface 1604 and a bus interface.

In an embodiment of the present disclosure, the device further includes: a program stored in the storage 1603 and executable on the processor 1601.

The transceiver 1602 is configured to transmit and receive data under the control of the processor.

The processor 1601 is configured to read the computer program in the memory and perform the following operations:
constructing a component power model for each component of the integrated energy system, and constructing a system model of the integrated energy system according to the component power models and power(s) at renewable energy nodes, wherein the component comprises one or more of the following: a heat generating component, a power generating component, a combined heat and power generating component, a power storage component, a heat storage component and a load, and the load includes at least one of a fixed thermal load, a fixed electrical load or a deferrable electrical load;
optimizing a flexibility of the integrated energy system to obtain flexibility optimization results, by utilizing the system model and predicted data from the renewable energy nodes;
determining feasibility constraints of the integrated energy system according to the flexibility optimization results; and
using the feasibility constraints and an operation cost of the integrated energy system as constraints and an optimization target respectively, and implementing a real-time dispatching of the integrated energy system with real-time data from the renewable energy nodes.

It should be understood that, in this embodiment of the present disclosure, when the computer program is executed by the processor 1601, each process of the above-mentioned dispatching method for the integrated energy system according to the embodiments can be implemented, and the same technical effect can be achieved. In order to avoid repetition, it is not repeated here.

In FIG. 16, bus architecture can include any number of interconnected buses and bridges. Specifically, various circuits of one or more processors represented by the processor 1601 and storage represented by the storage 1603 are linked together. The bus architecture can also link various other circuits, such as peripheral devices, voltage regulators and power management circuits, which are well known in the art and then will not be further described here. The bus interface provides an interface. The transceiver 1602 may be a plurality of elements, i.e., includes a transmitter and a receiver, and provides a unit for communicating with various other devices on a transmission medium. For different user devices, the user interface 1604 can also be an interface capable of externally connecting needed devices, including but not limited to a keypad, a display, a speaker, a microphone, a joystick and the like.

The processor 1601 is responsible for managing the bus architecture and general processes, and the storage 1603 can store data used by the processor 1601 when performing operations.

It should be noted that the device in this embodiment is a device corresponding to the above dispatching method for the integrated energy system, and the implementations in the above embodiments are all applicable to the embodiment of the device, and the same technical effects can be achieved. In this device, the transceiver 1602 and the storage 1603, as well as the transceiver 1602 and the processor 1601, can be connected in communication through the bus interface. The functions of the processor 1601 can also be realized by the transceiver 1602 and the functions of the transceiver 1602 can also be realized by the processor 1601. It should be noted here that the device according to the embodiment of this present disclosure can realize all the method steps implemented in the embodiment of the above method, and can achieve the same technical effect, so the same parts and beneficial effects in this embodiment are not detailed here.

In some embodiments of the present disclosure, a computer-readable storage medium is also provided, on which a program is stored, when the program is executed by a processor, the following steps are implemented:
constructing a component power model for each component of the integrated energy system, and constructing a system model of the integrated energy system according to the component power models and power(s) at renewable energy nodes, wherein the component comprises one or more of the following: a heat generating component, a power generating component, a combined heat and power generating component, a power storage component, a heat storage component and a load, and the load includes at least one of a fixed thermal load, a fixed electrical load or a deferrable electrical load;
optimizing a flexibility of the integrated energy system to obtain flexibility optimization results, by utilizing the system model and predicted data from the renewable energy nodes;
determining feasibility constraints of the integrated energy system according to the flexibility optimization results; and
using the feasibility constraints and an operation cost of the integrated energy system as constraints and an optimization target respectively, and implementing a real-time dispatching of the integrated energy system with real-time data from the renewable energy nodes.

When the program is executed by the processor, it can realize all the implementations in the dispatching method for the integrated energy system mentioned above, and can achieve the same technical effect. In order to avoid repetition, it is not repeated here.

Those of ordinary skilled in the art can realize that units and algorithm steps of various examples described in connection with the embodiments disclosed herein can be implemented in electronic hardware, or a combination of computer software and electronic hardware. Whether these functions are implemented in hardware or software depends on the specific application and design constraints of the technical scheme. Skilled people can use different methods to realize the described functions for each specific application, but this implementation should not be considered beyond the scope of this disclosure.

It can be clearly understood by those of ordinary skilled in the art that for the convenience and conciseness of description, the specific working processes of the systems, devices and units described above can refer to the corresponding processes in the aforementioned embodiments of method, and will not be repeated here.

In the embodiments of this present disclosure, it should be understood that the disclosed devices and methods can be realized in other ways. For example, the embodiments of the device described above is only schematic. For example, the division of the units is only a logical function division. In actual implementation, there may be other division methods, such as multiple units or components can be combined or integrated into another system, or some features can be ignored or not implemented. On the other hand, a mutual coupling or direct coupling or communication connection shown or discussed can be indirect coupling or communication connection through some interfaces, devices or units, which can be electrical, mechanical or other forms.

The units described as separate components may or may not be physically separated, and the components displayed as units may or may not be physical units, that is, they may be located in one place or distributed to multiple network units. Some or all of the units can be selected according to actual needs to achieve the purpose of the embodiments of this present disclosure.

In addition, each functional unit in each embodiment of this present disclosure can be integrated into one processing unit, or each unit can exist physically alone, or two or more units can be integrated into one unit.

The functions can be stored in a computer-readable storage medium if they are implemented in the form of software functional units and sold or used as independent products. Based on this understanding, a technical solution of the present disclosure, a part of this technical solution, or a part that contributes to the prior art, can be embodied in the form of a software product, which is stored in a storage medium and includes several instructions to make a computer device (which can be a personal computer, a server, a network device, etc.) execute all or part of the steps of the method described in various embodiments of the present disclosure. The aforementioned storage media include: USB flash disk, mobile hard disk, ROM, RAM, magnetic disk or optical disk and other media that can store program codes.

The above descriptions are merely specific embodiments of the present disclosure, but the scope of protection of the present disclosure is not limited thereto. Any person skilled in the art, familiar with the technical field of the present disclosure, can easily conceive variations or substitutions within the scope of technologies disclosed by the present disclosure, and all such variations or substitutions should be covered within the scope of protection of the present disclosure. Therefore, the scope of protection of the present disclosure should be defined by the claims.

What is claimed is:

1. A dispatching method for an integrated energy system, comprising:
constructing a component power model for each component of the integrated energy system, and constructing a system model of the integrated energy system according to the component power models and power(s) at renewable energy nodes, wherein the component comprises one or more of the following: a heat generating component, a power generating component, a combined heat and power generating component, a power storage component, a heat storage component and a load, and the load includes at least one of a fixed thermal load, a fixed electrical load or a deferrable electrical load;
optimizing a flexibility of the integrated energy system to obtain flexibility optimization results, by utilizing the system model and predicted data from the renewable energy nodes;
determining feasibility constraints of the integrated energy system according to the flexibility optimization results; and
using the feasibility constraints and an operation cost of the integrated energy system as constraints and an optimization target respectively, and implementing a real-time dispatching of the integrated energy system with real-time data from the renewable energy nodes.

2. The method according to claim 1, wherein the constructing the component power model for each component of the integrated energy system comprises one or more of the following:
constructing a heat generation model based on a thermal power output for the heat generating component;
constructing a power generation model based on an electric power output for the power generating component;
constructing a power generation model based on an electric power output and a heat generation model based on a thermal power output for the combined heat and power generating component;
constructing an electric energy model based on charging and discharging powers for the power storage component;
constructing a thermal energy model based on heat storage charging and discharging powers for the heat storage component;
constructing an electrical load model based on a fixed electric power for the fixed electrical load;
constructing a total power relaxation model based on a deferrable electric power for the deferrable electrical load; or
constructing a heat load model based on a fixed heat power for the fixed heat load.

3. The method according to claim 1, wherein the constructing the system model of the integrated energy system according to the component power models and the power(s) at the renewable energy nodes comprises:
constructing a real-time power balance model of electric energy of the integrated energy system according to the power(s) of the renewable energy nodes and electric powers of the components existing in the integrated energy system, wherein the electric powers include: an electric power output of the power generating components, an electric power output of the combined heat and power generating components, charging and discharging powers of the power storage components, a fixed electric power of the fixed electrical loads, or a deferrable electric power of the deferrable electrical loads; and,
constructing a real-time power balance model of thermal energy of the integrated energy system according to thermal powers of the components existing in the integrated energy system, wherein the thermal powers include: a thermal power of the heat generating components, a thermal power of the combined heat and power generating components, thermal storage charging and discharging powers of the thermal storage components, or a fixed thermal power of the fixed thermal loads.

4. The method according to claim 3, wherein the optimizing the flexibility of the integrated energy system to obtain the flexibility optimization results, by utilizing the system model and the predicted data from the renewable energy nodes comprises:
representing the power of the renewable energy nodes as a function of the electric powers of the components of the integrated energy system, according to the real-time power balance model of the electric energy of the integrated energy system;
quantitatively characterizing the flexibility of the integrated energy system in each time period as a difference between upper and lower limits of the power of the renewable energy nodes in the time period;
constructing a first objective function of the flexibilities of the integrated energy system in multiple time periods, according to the upper and lower limits of the flexibility of the integrated energy system in each time period, wherein the first objective function aims to maximize the flexibility and evenly distribute it in the multiple time periods; and performing an optimization calculation to obtain the system flexibility optimization results, based on the first objective function; wherein constraints of the first objective function include:
upper and lower limits of power output of each component of the integrated energy system in each time period satisfying the component power model corresponding to the component;
the upper and lower limits of the flexibility of the integrated energy system in each time period corresponding to the upper and lower limits of the power output of the component of the integrated energy system in the time period, respectively;
relative constraints of renewable energy; or
relative conditions of feasibility.

5. The method according to claim 4, wherein the relative constraints of renewable energy comprise:
the upper limit of the flexibility of the integrated energy system in each time period being greater than or equal to a product of a first coefficient and the power of a renewable energy node in the time period, and less than or equal to the power of a second renewable energy node in the time period;
the lower limit of the flexibility of the integrated energy system in each time period being greater than or equal to 0, and less than or equal to a product of a second coefficient and the power of the renewable energy node in the time period; or
the first coefficient and the second coefficient are both preset positive numbers greater than 0 and less than 1.

6. The method according to claim 4, wherein the relative conditions of the feasibility comprise:
the upper limit of the flexibility of the integrated energy system in each time period is greater than or equal to the lower limit of the flexibility of the integrated energy system in the time period; or
the upper limit of the power output of each component of the integrated energy system in each time period is greater than or equal to the lower limit of the power output of the component in the time period.

7. The method according to claim 1, wherein the determining the feasibility constraints of the integrated energy system according to the flexibility optimization results comprises:
obtaining upper and lower limits of outputs of the components of the integrated energy system in each time period, according to the flexibility optimization results;
determining upper and lower limits of a power of electric power supply and upper and lower limits of a power of thermal power supply of the integrated energy system, according to the upper and lower limits of the outputs of the components of the integrated energy system in each time period;
setting feasibility constraints of electric power supply, according to the upper and lower limits of the power of electric power supply of the integrated energy system, wherein the electric power supply of the integrated energy system includes: actual utilization power of renewable energy nodes running in real time in the current period, power purchased from a power grid in the current period, or electrical power output of each component running in real time in the current period; and
setting feasibility constraints of thermal power supply, according to the upper and lower limits of the power of thermal power supply of the integrated energy system, wherein the thermal power supply of the integrated energy system includes: thermal power output of each component running in real time in the current period.

8. The method according to claim 1, wherein the using the feasibility constraints and the operation cost of the integrated energy system as the constraints and the optimization target respectively, and implementing the real-time dispatching of the integrated energy system with the real-time data from the renewable energy nodes comprises:
constructing a second objective function of operation costs of power and heat generating sides of the integrated energy system, based on an operation cost of each component in the current period and power purchase cost of a power grid;
using an actual utilization power of the renewable energy nodes, a power purchased from the power grid, and electric and thermal power outputs of each component in the current period as decision variables at the power and heat generating sides, and optimizing dispatching strategies with a target of minimizing the second objective function to obtain dispatching strategies on the power and heat generating sides; and
determining dispatching strategies of the power storage components, the heat storage components and the loads, based on the dispatching strategies on the power and heat generating sides.

9. The method according to claim 8, wherein constraints of the second objective function comprise at least one of the following:
the feasibility constraints of the integrated energy system;
the thermal power output of the heat generating components satisfying the heat generation model of the heat generating components;
the electric power output of the power generating components satisfying the power generation model of the power generating components;
the thermal power output of the combined heat and power generating components satisfying the heat generation model of the combined heat and power generating components, and the electric power output of the combined heat and power generating components satisfying the power generation model of the combined heat and power generating components;
the power purchased from the power grid being greater than or equal to 0; or
the actual utilization power of the renewable energy nodes in the current period being greater than or equal to 0, and less than or equal to observed output power of the renewable energy nodes in the current period.

10. A dispatching device for an integrated energy system, comprising:
first constructing module configured to construct a component power model for each component of the integrated energy system, and construct a system model of the integrated energy system according to the component power models and power(s) at renewable energy nodes, wherein the component comprises one or more of the following: a heat generating component, a power generating component, a combined heat and power generating component, a power storage component, a heat storage component and a load, and the load includes at least one of a fixed thermal load, a fixed electrical load or a deferrable electrical load;
first optimizing module configured to optimize a flexibility of the integrated energy system to obtain flexibility optimization results, by utilizing the system model and predicted data from the renewable energy nodes;
first determining module configured to determine feasibility constraints of the integrated energy system according to the flexibility optimization results; and
dispatching module configured to use the feasibility constraints and an operation cost of the integrated energy system as constraints and an optimization target respectively, and implement a real-time dispatching of the integrated energy system with real-time data from the renewable energy nodes.

11. The device according to claim 10, wherein the first constructing module is further configured to construct a component power model for each component of the integrated energy system, which comprises one or more of the following:
construct a heat generation model based on a thermal power output for the heat generating component;
construct a power generation model based on an electric power output for the power generating component;
construct a power generation model based on an electric power output and a heat generation model based on a thermal power output for the combined heat and power generating component;
construct an electric energy model based on charging and discharging powers for the power storage component;
construct a thermal energy model based on heat storage charging and discharging powers for the heat storage component;
construct an electrical load model based on a fixed electric power for the fixed electrical load;
construct a total power relaxation model based on a deferrable electric power for the deferrable electrical load; or
constructing a heat load model based on a fixed heat power for the fixed heat load.

12. The device according to claim 10, wherein the first constructing module is further configured to:
construct a real-time power balance model of electric energy of the integrated energy system according to the power(s) of the renewable energy nodes and electric powers of the components existing in the integrated energy system, wherein the electric powers include: an electric power output of the power generating components, an electric power output of the combined heat and power generating components, charging and discharging powers of the power storage components, a fixed electric power of the fixed electrical loads, or a deferrable electric power of the deferrable electrical loads; and,
construct a real-time power balance model of thermal energy of the integrated energy system according to thermal powers of the components existing in the integrated energy system, wherein the thermal powers include: a thermal power of the heat generating components, a thermal power of the combined heat and power generating components, thermal storage charging and discharging powers of the thermal storage components, or a fixed thermal power of the fixed thermal loads.

13. The device according to claim 10, wherein the first optimizing module is further configured to:
represent the power of the renewable energy nodes as a function of the electric powers of the components of the integrated energy system, according to the real-time power balance model of the electric energy of the integrated energy system;
quantitatively characterize the flexibility of the integrated energy system in each time period as a difference between upper and lower limits of the power of the renewable energy nodes in the time period;
construct a first objective function of the flexibilities of the integrated energy system in multiple time periods, according to the upper and lower limits of the flexibility of the integrated energy system in each time period, wherein the first objective function aims to maximize the flexibility and evenly distribute it in the multiple time periods; and perform an optimization calculation to obtain the system flexibility optimization results, based on the first objective function; wherein constraints of the first objective function include:
upper and lower limits of power output of each component of the integrated energy system in each time period satisfying the component power model corresponding to the component;
the upper and lower limits of the flexibility of the integrated energy system in each time period corresponding to the upper and lower limits of the power output of the component of the integrated energy system in the time period, respectively;
relative constraints of renewable energy; or
relative conditions of feasibility.

14. The device according to claim 10, wherein the first determining module is further configured to:
obtain upper and lower limits of outputs of the components of the integrated energy system in each time period, according to the flexibility optimization results;
determine upper and lower limits of a power of electric power supply and upper and lower limits of a power of thermal power supply of the integrated energy system, according to the upper and lower limits of the outputs of the components of the integrated energy system in each time period;
set feasibility constraints of electric power supply, according to the upper and lower limits of the power of electric power supply of the integrated energy system, wherein the electric power supply of the integrated energy system includes: actual utilization power of renewable energy nodes running in real time in the current period, power purchased from a power grid in the current period, or electrical power output of each component running in real time in the current period; and
set feasibility constraints of thermal power supply, according to the upper and lower limits of the power of thermal power supply of the integrated energy system, wherein the thermal power supply of the integrated energy system includes: thermal power output of each component running in real time in the current period.

15. The device according to claim 10, wherein the dispatching module is further configured to:
construct a second objective function of operation costs of power and heat generating sides of the integrated energy system, based on an operation cost of each component in the current period and power purchase cost of a power grid;
use an actual utilization power of the renewable energy nodes, a power purchased from the power grid, and electric and thermal power outputs of each component in the current period as decision variables at the power and heat generating sides, and optimize dispatching strategies with a target of minimizing the second objective function to obtain dispatching strategies on the power and heat generating sides; and
determine dispatching strategies of the power storage components, the heat storage components and the loads, based on the dispatching strategies on the power and heat generating sides.
